(19) United States
(12) Patent Application Publication
(10) Pub. No.: US 2017/0351423 A1
(43) Pub. Date: Dec. 7, 2017

(54) INFORMATION PROCESSING APPARATUS, INFORMATION PROCESSING METHOD AND COMPUTER-READABLE STORAGE MEDIUM STORING PROGRAM

(71) Applicant: CANON KABUSHIKI KAISHA, Tokyo (JP)

(72) Inventor: Shunichi Yokoyama, Kawasaki-shi (JP)

(21) Appl. No.: 15/605,144

(22) Filed: May 25, 2017

(30) Foreign Application Priority Data
Jun. 1, 2016 (JP) 2016-110251

(51) Int. Cl. G06F 3/0488; G06F 3/041; G06F 3/0484; G06F 3/0482

(52) U.S. Cl. CPC G06F 3/04883; G06F 3/04845; G06F 3/0416; G06F 3/0482; G06F 2203/04808

(57) ABSTRACT

The present invention improves operability by controlling operation received from a user according to an operation unit for a touch panel. A display apparatus according to an embodiment of the present invention includes: a display that displays an image on a screen; a touch detector that detects contact on the touch screen; an area sensor that obtains an area of the contact on the screen; and a changing unit that changes UI (User Interface) for inputting a predetermined instruction is changed based on the contact detected by the touch detector.

### BACKGROUND OF THE INVENTION

### Field of the Invention

The present invention relates to an information processing apparatus, an information processing method and a computer-readable storage medium storing a program, and particularly, to an information processing apparatus including a touch detector, an information processing method and a computer-readable storage medium storing a program.

### Description of the Related Art

Conventionally, there is a display apparatus including a touch panel and configured to perform various controls based on information of touch to a touch panel by a user. The display apparatus including the touch panel displays a virtual operation unit, such as buttons, for receiving operation by the user. For example, the user brings a finger of the user into contact with the operation unit displayed on the display apparatus to perform operation. There are individual differences in the size of the finger of the user, and the operation of a small operation unit may be difficult for a user with large fingers. In Japanese Patent Application Laid-Open No. H06-83537, when a user uses a finger to touch a touch panel, the size of an input range of an operation unit displayed on a display apparatus is changed and displayed according to the size of the finger of the user.

### SUMMARY OF THE INVENTION

Other than the finger of the user, there are various units for touching the touch panel such as a tool like a touch pen. The operability on the touch panel varies depending on the unit for touching the touch panel. For example, gesture operation, such as flicking, is easy in the operation by the finger of the user. On the other hand, designation of detailed coordinates on the screen is easy in the operation using a tool such as a touch pen. The information displayed on the touch panel, the content that can be instructed, and the type of operation for issuing an instruction (for example, single tap, long tap, double tap and flick) are diversified, and improvement in the operability of the user is desired.

The present invention solves the problem, and an object of the present invention is to improve the operability by controlling the operation that can be input by the user according to the operation unit for the touch panel.

A first aspect of the present invention provides an information processing apparatus including: a display that displays an image on a screen; a touch detector that detects contact on the screen; an area sensor that obtains an area of the contact on the screen; and a changing unit that changes UI (User Interface) for inputting a predetermined instruction based on the contact detected by the touch detector.

A second aspect of the present invention provides an information processing method including: displaying an image on a screen; detecting contact on the screen; obtaining an area of the contact on the screen; and changing UI (User Interface) for inputting a predetermined instruction based on the detected contact.

A third aspect of the present invention provides a non-transitory computer-readable storage medium storing a program, the program causing a computer to execute: displaying an image on a screen; detecting contact on the screen; obtaining an area of the contact on the screen; and changing UI (User Interface) for inputting a predetermined instruction based on the detected contact.

According to the present invention, the operability can be improved by changing the input operation received from the user according to the area of contact on the touch panel in the display apparatus including the touch panel.

Further features of the present invention will become apparent from the following description of exemplary embodiments with reference to the attached drawings.

### BRIEF DESCRIPTION OF THE DRAWINGS

FIG. 1 is a schematic configuration diagram of a display apparatus according to a first embodiment.

FIG. 2A is an external view of the display apparatus according to the first embodiment.

FIG. 2B is an exploded view of a touch screen according to the first embodiment.

FIG. 3 is a schematic diagram of an exemplary user interface according to the first embodiment.

FIG. 4 is a diagram illustrating a flow chart of a display method according to the first embodiment.

FIG. 5A is a schematic diagram of an exemplary user interface according to the first embodiment.

FIG. 5B is a schematic diagram of an exemplary user interface according to the first embodiment.

FIG. 6 is a diagram illustrating a flow chart of a control process for touch panel operation according to the first embodiment.

FIG. 7 is a diagram illustrating a flow chart of a control process for finger operation according to the first embodiment.

FIG. 8A is a schematic diagram of an exemplary user interface according to a second embodiment.

FIG. 8B is a schematic diagram of an exemplary user interface according to the second embodiment.

FIG. 8C is a schematic diagram of an exemplary user interface according to the second embodiment.

FIG. 9 is a schematic diagram of an exemplary user interface according to a third embodiment.

FIG. 10A is a schematic diagram of an exemplary user interface according to the third embodiment.

FIG. 10B is a schematic diagram of an exemplary user interface according to the third embodiment.

### DESCRIPTION OF THE EMBODIMENTS

Preferred embodiments of the present invention will now be described in detail in accordance with the accompanying drawings.

Embodiments of the present invention will now be described in detail with reference to the drawings. The embodiments described below are examples for realizing the present invention, and the embodiments should be appropriately modified or changed according to the configuration and various conditions of the device in which the present invention is applied. The present invention is not limited to the following embodiments.

### First Embodiment

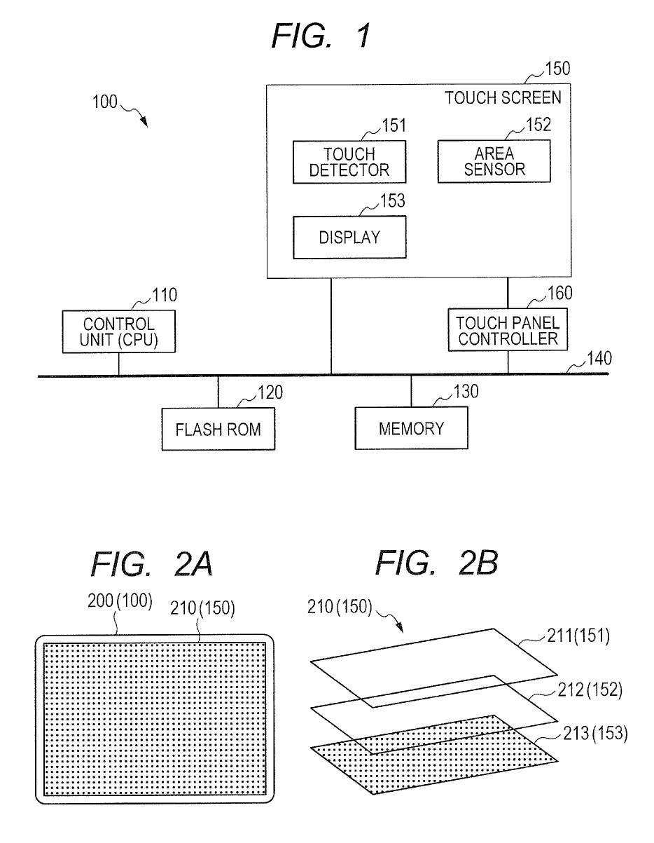

FIG. 1 is a schematic configuration diagram of an exemplary display apparatus 100 according to the present embodiment. The display apparatus 100 includes a touch panel and can receive various instructions from a user by detecting operation of the touch panel by the user. The display apparatus 100 is a kind of computer as an information processing apparatus and includes a control unit (CPU) 110, a flash ROM 120, a memory 130, a touch screen 150 and a touch panel controller 160. The components of the display apparatus 100 are connected by a bus 140. The bus 140 has a function of transmitting commands from the control unit 110 to the components of the display apparatus 100 and transferring data between the memory 130 and the components of the display apparatus 100. The touch screen 150 is in a displaying unit that displays images and includes a touch detector 151, an area sensor 152 and a display 153. The images displayed by the touch screen 150 include arbitrary data visually recognized by the user, such as a user interface, characters and photographs.

The control unit 110 controls the entire display apparatus 100 and has a function of displaying image data on the display 153 and a function of displaying an arbitrary operation unit, such as buttons, for operation by the user on the display 153. The control unit 110 also has a function of receiving signal information output by the touch panel controller 160 and a function of applying image conversion process, such as rotation process, color conversion process and trimming process, to the image data. Specifically, the control unit 110 reads a program for executing a method illustrated in FIGS. 4, 6 and 7 described later from the flash ROM 120 and executes steps included in the method. The flash ROM 120 is used to store the program operated by the control unit 110 and save various configuration data. The flash ROM 120 is a non-volatile memory, and recorded data is held even when the power of the display apparatus 100 is off. The memory 130 is a volatile or non-volatile memory used as a work memory of the control unit 110 and as a video memory for holding video data and graphic data displayed on the display 153.

The touch detector 151 includes a touch panel that receives operation by the user using an operation unit, such as a finger and a touch pen. The operation using the finger denotes operation of bringing part of the body of the user into direct contact with the touch panel. The operation using the touch pen (also called stylus) denotes operation of bringing a tool held by the user into contact with the touch panel. The touch detector 151 can detect the following types of operation.

a. Touch (contact) to the touch panel using the finger or the touch pen (hereinafter, called touch-down).

b. State that the finger or the touch pen is touching the touch panel (hereinafter, called touch-on).

c. Movement of the finger or the touch pen while touching the touch panel (hereinafter, called move).

d. Removal of the finger or the touch pen touching the touch panel from the touch panel (hereinafter, called touch-up).

e. State that nothing is touching the touch panel (hereinafter, called touch-off).

The touch detector 151 can also detect the number of spots touched at the same time and can acquire coordinate information of all points touched at the same time. The touch detector 151 determines that pinch-in operation is performed when coordinates of the touch of two points touched at the same time are moved in directions in which the distance between the two points is reduced. The touch detector 151 determines that pinch-out operation is performed when the coordinates of the touch are moved in directions in which the distance between the two points is enlarged. For each vertical component and horizontal component on the touch panel, the touch detector 151 can determine the direction of movement of the finger or the touch pen moved on the touch panel based on a change in the coordinates of the touch.

Touch-up after touch-down and certain movement on the touch panel will be called drawing a stroke. Operation of quickly drawing a stroke on the touch panel will be called flick. The flick is operation of quickly moving the finger or the touch pen touching the touch panel for some distance and detaching the finger or the touch pen. In other words, the flick is operation of quickly tracing the touch panel so as to tap the touch panel by the finger or the touch pen. When the touch detector 151 detects a movement of equal to or greater than a predetermined distance at equal to or greater than a predetermined speed and detects touch-up, the touch detector 151 determines that flicking is performed. When the touch detector 151 detects touch-up within a predetermined time after touch-on, the touch detector 151 determines that tapping (single tap) is performed. The touch detector 151 determines that double tap is performed when detecting a tap again within a predetermined time after the tap. The touch detector 151 outputs information of the acquired coordinates of the touch and information of the determined operation type.

The area sensor 152 is an area sensing unit and has a function of calculating and obtaining a contact area of an operation unit, such as a finger and a touch pen, touching the touch screen 150 when the user uses the operation unit to touch the touch screen 150. The display 153 is, for example, a liquid crystal display or an organic EL (Electro Luminescence) display, and has a function of displaying content of video data held by the memory 130. The area sensor 152 outputs information of the calculated area of the touch.

The touch panel controller 160 has a function of receiving a signal including the coordinate information and the operation type information received from the touch detector 151 and a signal including the area information received from the area sensor 152. The touch panel controller 160 also has a function of converting the signals into a predetermined data format that can be recognized by the control unit 110 and outputting the signals to the control unit 110.

FIG. 2A is an external view of a display apparatus according to the present embodiment, and FIG. 2B is an exploded view illustrating a physical configuration of a touch screen according to the present embodiment. A display apparatus 200 (display apparatus 100 in FIG. 1) includes a touch screen 210 (touch screen 150 in FIG. 1) as a display screen. The touch screen 210 includes a display 213 (display 153 in FIG. 1), an area sensor 212 (area sensor 152 in FIG. 1) and a touch detector 211 (touch detector 151 in FIG. 1).

The area sensor 212 is arranged over the display 213, and the touch detector 211 is arranged over the area sensor 212. Although the display 213, the area sensor 212 and the touch detector 211 are displayed apart from each other for the visibility in the exploded view of FIG. 2B, the display 213, the area sensor 212 and the touch detector 211 are actually integrated to form the touch screen 210. The type of the touch operation detected by the touch screen 210 and the area of the touch at this time are output to the control unit 110 through the touch panel controller 160.

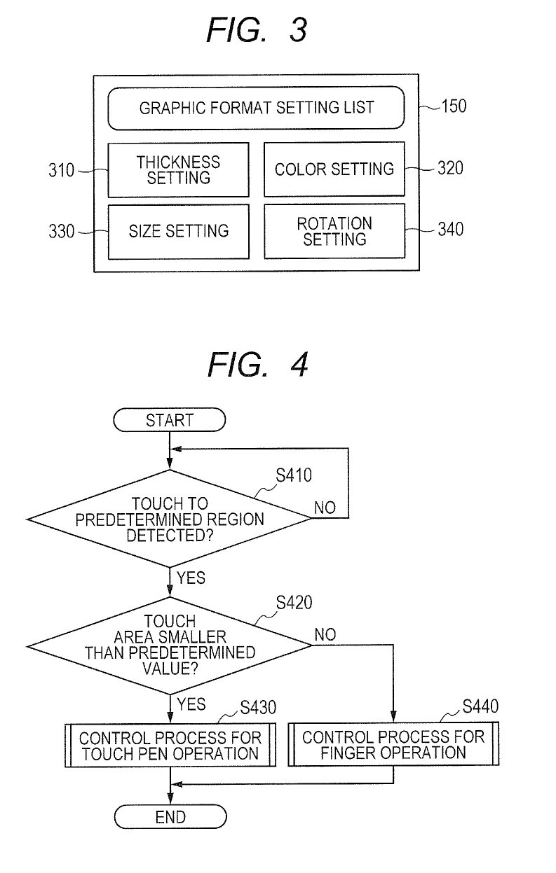

FIG. 3 is a schematic diagram of an exemplary user interface (hereinafter, called UI) of a formatting screen displayed on the touch screen 150 according to the present embodiment. In the present embodiment, the touch screen 150 displays a screen for setting a format of graphics. The touch screen 150 displays virtual buttons 310, 320, 330 and 340. Reaction regions of the buttons 310 to 340 are defined as predetermined regions for detecting a touch by the user. The control unit 110 determines whether the user has touched a predetermined region of the buttons 310 to 340 and further detects the area of the touch.

FIG. 4 is a diagram illustrating a flow chart of a display method (an information processing method) according to the present embodiment. The control unit 110 first detects a touch to a predetermined region on the touch screen 150 based on the data output from the touch panel controller 160 (step S410). At this point, the control unit 110 also detects the area of the touch. The predetermined region is defined by, for example, a button displayed on the touch screen 150 as illustrated in FIG. 3. If the control unit 110 detects a touch to a predetermined region in step S410, the control unit 110 proceeds to step S420. If the control unit 110 does not detect a touch to a predetermined region in step S410, the control unit 110 returns to step S410 and repeats detecting a touch to a predetermined region.

Next, the control unit 110 determines whether the touch area at the detection of the touch to the predetermined region is smaller than a predetermined value based on the signal received from the area sensor 152 (step S420). If the control unit 110 determines that the touch area is smaller than the predetermined value in step S420, the control unit 110 executes a control process for touch pen operation described later (step S430) and then ends the display method according to the present embodiment. If the control unit 110 determines that the touch area is equal to or greater than the predetermined value in step S420, the control unit 110 executes a control process for finger operation described later (step S440) and then ends the display method according to the present embodiment. The control unit 110 may execute the control process for touch pen operation if the touch area is equal to or smaller than the predetermined value and may execute the control process for finger operation if the touch area is greater than the predetermined value.

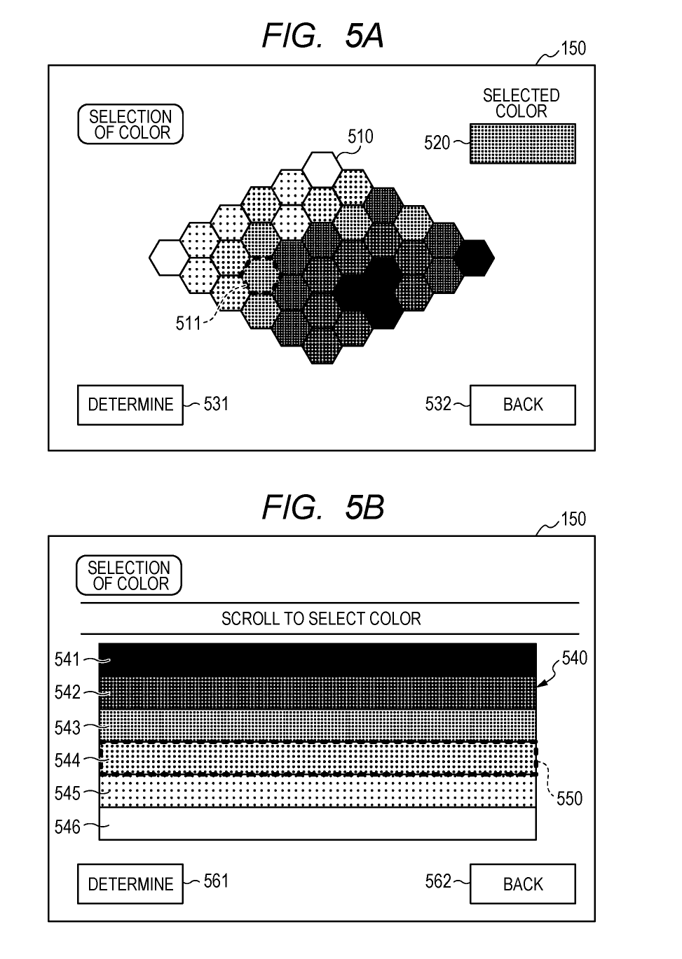

A method of selecting a color on the touch screen in the present embodiment will be described. FIG. 5A is a schematic diagram of an exemplary UI for touch pen operation displayed on the touch screen 150 according to the present embodiment. For example, when the region of the button 320 is touched by the touch pen in FIG. 3, the control unit 110 displays the UI as illustrated in FIG. 5A as a UI for touch pen operation on the touch screen 150. The touch screen 150 displays color selection buttons 510 as selection regions and further displays colors as choices on a plurality of hexagonal elements forming the color selection buttons 510. The touch screen 150 displays a selection frame 511 (dotted line) surrounding the element indicating the selected color, on one of the elements forming the color selection buttons 510. The touch screen 150 displays, on a selected color displaying unit 520, the color selected by touching one of the elements forming the color selection buttons 510.

The touch screen 150 further displays a determination button 531 and a back button 532. When the control unit 110 detects a touch of the determination button 531, the control unit 110 confirms the selected color and ends displaying the UI for touch pen operation. When the control unit 110 detects a touch of the back button 532, the control unit 110 ends displaying the UI for touch pen operation without confirming the color.

FIG. 5B is a schematic diagram of an exemplary UI for finger operation displayed on the touch screen 150 according to the present embodiment. For example, when the region of the button 320 is touched by the finger in FIG. 3, the control unit 110 displays the UI as illustrated in FIG. 5B as a UI for finger operation on the touch screen 150. The touch screen 150 displays color selection buttons 540 as selection regions and displays colors as choices on a plurality of rectangular elements of frames 541 to 546 forming the color selection buttons 540. In the example of FIG. 5B, the touch screen 150 displays only six colors among the selectable colors in the frames 541 to 546 and controls the colors displayed in the frames 541 to 546 according to move operation (scroll operation) by the user. The touch screen 150 displays a selection frame 550 (dotted line) indicating that the color in the frame is selected, on one frame 544 of the frames forming the color selection buttons 540.

The touch screen 150 further displays a determination button 561 and a back button 562. When the control unit 110 detects a touch of the determination button 561, the control unit 110 confirms the selected color and ends displaying the UI for finger operation. When the control unit 110 detects a touch of the back button 562, the control unit 110 ends displaying the UI for finger operation without confirming the color.

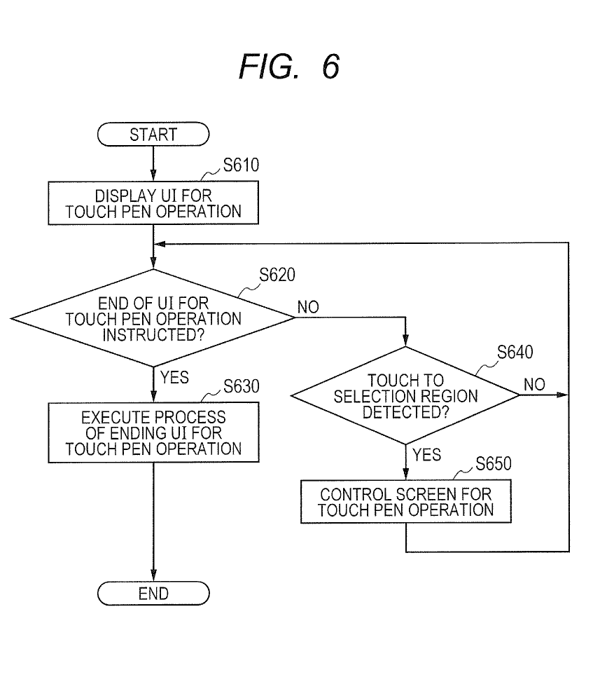

FIG. 6 is a diagram illustrating a flow chart of the control process for touch pen operation according to the present embodiment. The control unit 110 first displays, on the touch screen 150, the UI for touch pen operation illustrated in FIG. 5A (step S610). Next, the control unit 110 determines whether an end instruction from the user is received in the UI for touch pen operation (step S620). Specifically, when the control unit 110 detects a touch of one of the determination button 531 and the back button 532 on the UI for touch pen operation, the control unit 110 determines that the end instruction of the UI for touch pen operation is received.

If the control unit 110 determines that the end instruction is received in step S620, the control unit 110 executes a process of ending the UI for touch pen operation (step S630). Specifically, the control unit 110 displays the formatting screen of graphics of FIG. 3 again on the touch screen 150 to execute the process of ending the UI for touch pen operation. The control unit 110 ends the control process for touch pen operation after step S630.

If the control unit 110 determines that the end instruction is not received in step S620, the control unit 110 proceeds to step S640. The control unit 110 determines whether a touch is detected in the selection regions defined by the color selection buttons 510 of FIG. 5A based on the coordinate information notified from the touch panel controller 160 (step S640). If the control unit 110 determines that a touch in the selection regions is not detected in step S640, the control unit 110 returns to step S620 and repeats the process. If the control unit 110 determines that a touch is detected in the selection regions in step S640, the control unit 110 controls the screen based on the touched position (step S650). Specifically, the control unit 110 displays the selection frame 511 on the hexagonal element including the touched coordinates and displays the color of the element in the selected color displaying unit 520. After step S650, the control unit 110 returns to step S620 and repeats the process.

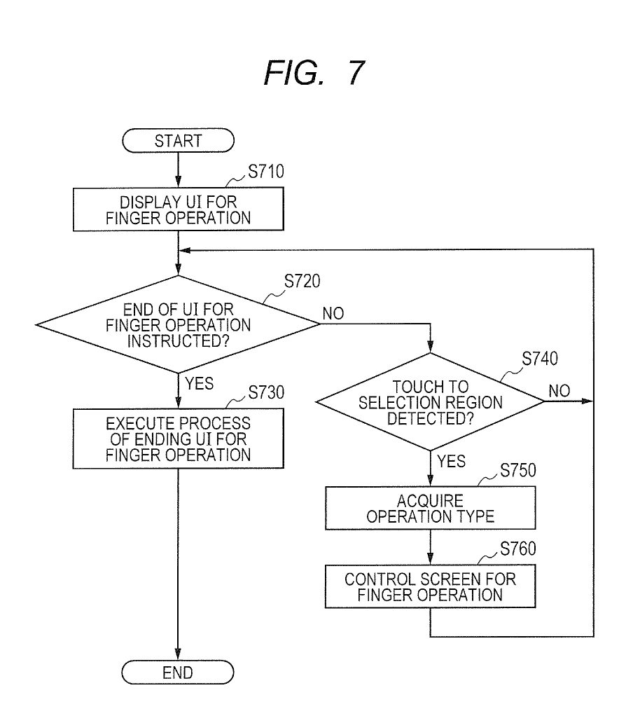

FIG. 7 is a diagram illustrating a flow chart of the control process for finger operation according to the present embodiment.

The control unit 110 first displays the UI for finger operation illustrated in FIG. 5B on the touch screen 150 (step S710). Next, the control unit 110 determines whether an end instruction from the user is received in the UI for finger operation (step S720). Specifically, when the control unit 110 detects a touch of one of the determination button 561 and the back button 562 on the UI for finger operation, the control unit 110 determines that the end instruction for finger operation is received.

If the control unit 110 determines that the end instruction is received in step S720, the control unit 110 executes a process of ending the UI for finger operation (step S730). Specifically, the control unit 110 displays the formatting screen of graphics of FIG. 3 again on the touch screen 150 to execute the process of ending the UI for finger operation. The control unit 110 ends the control process for finger operation after step S730.

If the control unit 110 determines that the end instruction is not received in step S720, the control unit 110 proceeds to step S740. The control unit 110 determines whether a touch is detected in the selection regions defined by the color selection buttons 540 of FIG. 5B based on the coordinate information notified from the touch panel controller 160 (step S740). If the control unit 110 determines that a touch is not detected in the selection regions in step S740, the control unit 110 returns to step S720 and repeats the process.

If the control unit 110 determines that a touch is detected in the selection regions in step S740, the control unit 110 acquires the type of the operation performed on the touch screen 150 based on the operation type information notified from the touch panel controller 160 (step S750). The control unit 110 then controls the screen for finger operation based on the operation type acquired in step S750 (step S760). If the operation type acquired in step S750 is move, the control unit 110 determines the colors to be displayed on the color selection buttons 540 of FIG. 5B according to the moving distance on the touch screen 150. For example, if a movement in the downward direction of the screen of FIG. 5B is detected, the control unit 110 displays, in the frame 542, the color displayed in the frame 541 and displays, in the frame 543, the color displayed in the frame 542. Therefore, the control unit 110 moves the colors displayed in the frames 541 to 546 downward and displays the colors. The control unit 110 displays, in the frame 541, a new color not displayed on the screen and controls the content of the display so as not to display, on the screen, the color displayed in the frame 546. Other than the operation type illustrated here, the control unit 110 can control the screen to change the input operation when the operation type is at least one of single tap, double tap, move, flick, pinch-in and pinch-out. After step S760, the control unit 110 returns to step S720 and repeats the process.

As described, the display apparatus 100 according to the present embodiment changes the operation that can be input on the touch screen 150 to receive a predetermined instruction (for example, the selection of color) based on the area of contact (touch area) on the touch screen 150 touched by the user. In this case, the control unit (CPU) 110 functions as a changing unit that changes the operation for inputting the predetermined instruction on the touch screen 150. In other words, based on the area of contact (touch area) on the touch screen 150 touched by the user while the touch screen 150 displays a first user interface, the display apparatus 100 changes the interface to a second user interface different from the first user interface. More specifically, if the touch area detected by the area sensor 152 is greater than the predetermined value or not smaller than the predetermined value, the display apparatus 100 displays the UI for finger operation to switch the function to be executed according to each type of input operation. On the other hand, if the touch area detected by the area sensor 152 is smaller than the predetermined value or not greater than the predetermined value, the display apparatus 100 displays the UI for touch pen operation to switch the function to be executed according to each touch position detected by the touch detector 151.

For example, if the detected touch area is smaller than the predetermined value or not greater than the predetermined value, the display apparatus 100 displays a screen that allows designating detailed coordinates. If the detected touch area is greater than the predetermined value or not smaller than the predetermined value, the display apparatus 100 displays a screen that allows input operation using the move. When the touch pen is used as the operation unit, the touch area is small, and detailed coordinates can be easily designated. Therefore, a screen for directly designating one of many displayed colors is displayed as illustrated in FIG. 5A. On the other hand, when the finger is used as the operation unit, the touch area is large, and detailed coordinates cannot be easily designated. However, gesture operation, such as move, can be easily performed. Therefore, a screen for designating a color while changing the displayed colors by move operation is displayed as illustrated in FIG. 5B. In this way, providing an appropriate input operation method according to the operation unit, such as a finger and a touch pen, can solve the problem that the operability is deteriorated due to the differences in the operation unit.

### Second Embodiment

The present embodiment relates to a method of determining a trimming range of a reproduced image on the touch screen. The device configuration according to the present embodiment is the same as in the first embodiment, and the description will not be repeated. In a display method according to the present embodiment, step S410 of FIG. 4, steps S610, S640 and S650 of FIG. 6, and steps S710, S740 and S760 of FIG. 7 described in the first embodiment are different, and the other steps are the same. The differences from the first embodiment will be described.

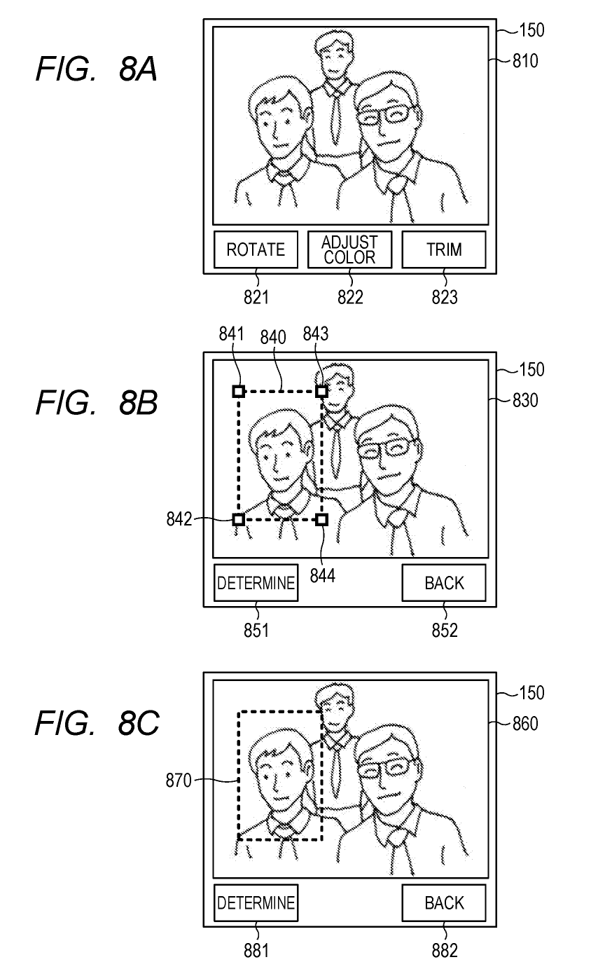

FIG. 8A is a schematic diagram of an exemplary UI of an edit screen displayed on the touch screen 150 according to the present embodiment. The control unit 110 displays the UI of the edit screen before step S410 of FIG. 4. In the present embodiment, the touch screen 150 displays a screen for editing an image. The touch screen 150 displays a reproduced image 810 and virtual buttons 821, 822 and 823. The reproduced image 810 is an image to be edited. Reaction regions of the buttons 821 to 823 are defined as predetermined regions for detecting a touch by the user. In step S410 of FIG. 4, the control unit 110 determines whether the user has touched a predetermined region of the buttons 821 to 823 and further detects the area of the touch.

FIG. 8B is a schematic diagram of an exemplary UI for touch pen operation displayed on the touch screen 150 according to the present embodiment. The control unit 110 displays the UI for touch pen operation in step S610 of FIG. 6. For example, when the region of the button 823 is touched by the touch pen in FIG. 8A (that is, when the touch area is smaller than the predetermined value), the control unit 110 displays the UI as illustrated in FIG. 8B as a UI for touch pen operation on the touch screen 150. In the present embodiment, the touch screen 150 displays a screen for setting a selection range of trimming as a UI for touch pen operation. The touch screen 150 displays vertex selection buttons 841 to 844 and a rectangular frame 840 (dotted line) having the vertex selection buttons 841 to 844 as four vertices, along with a reproduced image 830. The reproduced image 830 is the same as the reproduced image 810 of FIG. 8A and is an image to be trimmed. The frame 840 indicates a trimming range. After the user touches an arbitrary vertex among the four vertices, the control unit 110 moves the vertex to an arbitrary place touched by the user next.

The touch screen 150 further displays a determination button 851 and a back button 852. When the control unit 110 detects a touch of the determination button 851, the control unit 110 confirms the selected trimming range and ends displaying the UI for touch pen operation. When the control unit 110 detects a touch of the back button 852, the control unit 110 ends displaying the UI for touch pen operation without confirming the trimming range.

In the present embodiment, the control unit 110 sets the regions of the vertex selection buttons 841 to 844 of FIG. 8B as selection regions of the user in step S640 of FIG. 6. In step S650 of FIG. 6, the control unit 110 controls the screen based on the touched coordinates. Specifically, the control unit 110 sets one of the vertex selection buttons 841 to 844 including the touched coordinates as a vertex selection button to be moved. The control unit 110 then moves and displays the vertex selection button to be moved, at the place touched next. At the same time, the control unit 110 updates and displays the rectangular frame 840 such that the vertex selection buttons 841 to 844 after the movement serve as vertices of the frame 840.

FIG. 8C is a schematic diagram of an exemplary UI for finger operation displayed on the touch screen 150 according to the present embodiment. The control unit 110 displays the UI for finger operation in step S710 of FIG. 7. For example, when the region of the button 823 is touched by the finger in FIG. 8A (that is, when the touch area is equal to or greater than the predetermined value), the control unit 110 displays the UI as illustrated in FIG. 8C as a UI for finger operation on the touch screen 150. In the present embodiment, the touch screen 150 displays a screen for setting a selection range of trimming as a UI for finger operation. The touch screen 150 displays a rectangular frame 870 (dotted line) along with a reproduced image 860. The reproduced image 860 is the same as the reproduced image 810 of FIG. 8A and is an image to be trimmed. The frame 870 indicates a trimming range.

The touch screen 150 further displays a determination button 881 and a back button 882. When the control unit 110 detects a touch of the determination button 881, the control unit 110 confirms the selected trimming range and ends displaying the UI for finger operation. When the control unit 110 detects a touch of the back button 882, the control unit 110 ends displaying the UI for finger operation without confirming the trimming range.

In the present embodiment, the control unit 110 sets the region of the rectangular frame 870 of FIG. 8C as a selection region in step S740 of FIG. 7. If the operation type acquired in step S750 is move, the control unit 110 moves the frame 870 in the direction of the move on the touch screen 150 and displays the frame 870 in step S760 of FIG. 7. If the operation type acquired in step S750 is pinch-in, the control unit 110 reduces the frame 870 around the center coordinates of the frame 870 and displays the frame 870. If the operation type acquired in step S750 is pinch-out, the control unit 110 enlarges the frame 870 around the center coordinates of the frame 870 and displays the frame 870. Other than the operation type illustrated here, the control unit 110 can control the screen to change the input operation when the operation type is at least one of single tap, double tap, move, flick, pinch-in and pinch-out.

As described, the display apparatus 100 according to the present embodiment displays a screen that allows individually designating the vertices of the rectangular frame indicating the trimming range if the detected touch area is smaller than the predetermined value in the determination of the trimming range. The display apparatus 100 displays a screen that allows setting the trimming range by using input operation using gesture operation, such as move, pinch-in and pinch-out, if the detected touch area is equal to or greater than the predetermined value. In this way, providing an appropriate input operation method according to the touch operation unit, such as a finger and a touch pen, can solve the problem that the operability is deteriorated due to the differences in the operation units.

### Third Embodiment

The present embodiment relates to a method of enlarging and reducing a reproduced image and switching an image on the touch screen. The device configuration according to the present embodiment is the same as in the first embodiment, and the description will not be repeated. In a display method according to the present embodiment, step S410 of FIG. 4, steps S610, S640 and S650 of FIG. 6, and steps S710, S740 and S760 of FIG. 7 described in the first embodiment are different, and the other steps are the same. The differences from the first embodiment will be described.

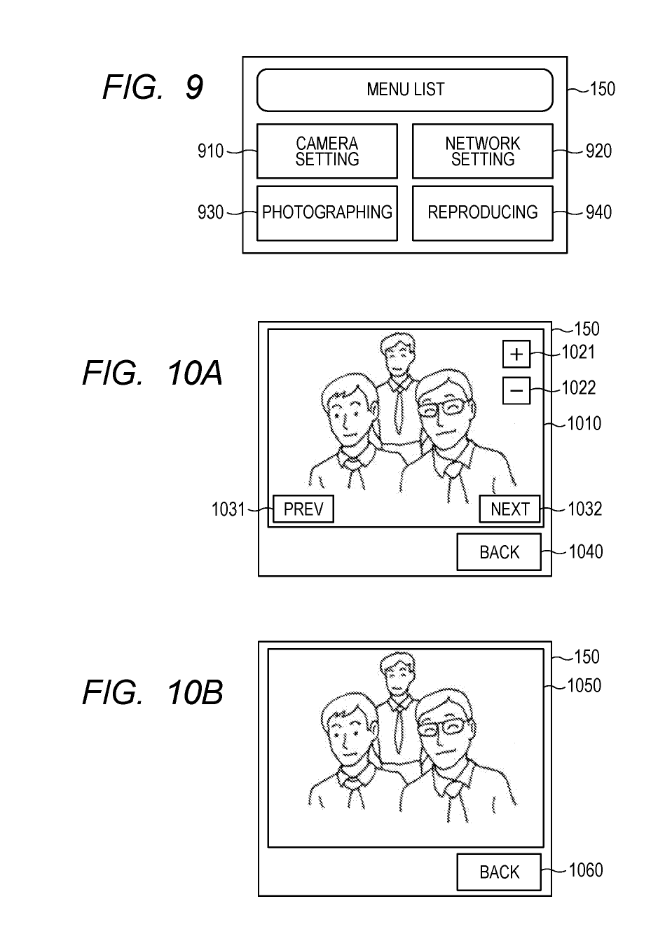

FIG. 9 is a schematic diagram of an exemplary UI of a menu screen displayed on the touch screen 150 according to the present embodiment. The control unit 110 displays the UI of the menu screen before step S410 of FIG. 4. In the present embodiment, the touch screen 150 displays a screen for selecting a function. The touch screen 150 displays virtual buttons 910, 920, 930 and 940. Reaction regions of the buttons 910 to 940 are defined as predetermined regions for detecting a touch by the user in step S410 of FIG. 4. In step S410 of FIG. 4, the control unit 110 determines whether the user has touched a predetermined region of the buttons 910 to 940 and further detects the area of the touch.

FIG. 10A is a schematic diagram of an exemplary UI for touch pen operation displayed on the touch screen 150 according to the present embodiment. The control unit 110 displays the UI for touch pen operation in step S610 of FIG. 6. For example, when the region of the button 940 is touched by the touch pen in FIG. 9 (that is, when the touch area is smaller than the predetermined value), the control unit 110 displays the UI as illustrated in FIG. 10A as a UI for touch pen operation on the touch screen 150. In the present embodiment, the touch screen 150 displays a screen for reproducing an image as a UI for touch pen operation. The touch screen 150 displays an enlargement button 1021, a reduction button 1022, a rewind button 1031, a forward button 1032 and a back button 1040 along with a reproduced image 1010. The enlargement button 1021 is a button for enlarging and displaying the reproduced image 1010. The reduction button 1022 is a button for reducing and displaying the reproduced image 1010. The forward button 1032 is a button for changing the reproduced image 1010 to the next image and displaying the image. The rewind button 1031 is a button for changing the reproduced image 1010 to the previous image and displaying the image. When the control unit 110 detects a touch of the back button 1040, the control unit 110 ends displaying the UI for touch pen operation.

In the present embodiment, the control unit 110 sets regions of the buttons 1021, 1022, 1031 and 1032 of FIG. 10A as selection regions of the user in step S640 of FIG. 6. In step S650 of FIG. 6, the control unit 110 controls the screen based on the touched coordinates. Specifically, the control unit 110 controls the touch screen 150 to execute the function allocated to the button including the touched coordinates among the buttons 1021, 1022, 1031 and 1032.

FIG. 10B is a schematic diagram of an exemplary UI for finger operation displayed on the touch screen 150 according to the present embodiment. The control unit 110 displays the UI for finger operation in step S710 of FIG. 7. For example, when the region of the button 940 is touched by the finger in FIG. 9 (that is, when the touch area is equal to or greater than the predetermined value), the control unit 110 displays the UI as illustrated in FIG. 10B as a UI for finger operation on the touch screen 150. In the present embodiment, the touch screen 150 displays a screen for reproducing an image as the UI for finger operation. The touch screen 150 displays a back button 1060 along with the reproduced image 1050. When the control unit 110 detects a touch of the back button 1060, the control unit 110 ends displaying the UI for finger operation.

In the present embodiment, the control unit 110 sets the region of the reproduced image 1050 of FIG. 10B as a selection region in step S740 of FIG. 7. When the operation type acquired in step S750 is pinch-in, the control unit 110 reduces and displays the reproduced image 1050 in step S760 of FIG. 7. When the operation type acquired in step S750 is pinch-out, the control unit 110 enlarges and displays the reproduced image 1050. When the operation type acquired in step S750 is single tap, the control unit 110 displays the reproduced image 1050 at the normal magnification. When the operation type acquired in step S750 is double tap, the control unit 110 enlarges the reproduced image 1050 at a predetermined enlargement rate and displays the reproduced image 1050. When the operation type acquired in step S750 is flick, the control unit 110 changes the reproduced image 1050 according to the direction of the flick and displays the reproduced image 1050. For example, when the direction of the flick is to the right of the touch screen 150, the control unit 110 changes the reproduced image 1050 to the next image and displays the image. When the direction of the flick is to the left of the touch screen 150, the control unit 110 changes the reproduced image 1050 to the previous image and displays the image. Other than the operation type illustrated here, the control unit 110 can control the screen to change the input operation when the operation type is at least one of single tap, double tap, move, flick, pinch-in and pinch-out.

As described, the display apparatus 100 according to the present embodiment changes the input operation received on the touch screen 150 to execute different functions according to the touched places if the detected touch area is smaller than the predetermined value in the reproduction of the image. The display apparatus 100 changes the input operation to execute different functions according to gesture operation, such as pinch-in, pinch-out, single tap, double tap and flick, if the detected touch area is equal to or greater than the predetermined value. In this way, providing an appropriate input operation method according to the touch operation unit, such as a finger and a touch pen, can solve the problem that the operability is deteriorated due to the differences in the operation units.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-110251, filed Jun. 1, 2016, which is hereby incorporated by reference herein in its entirety.

What is claimed is:

1. An information processing apparatus comprising:
a display that displays an image on a screen;
a touch detector that detects contact on the screen;
an area sensor that obtains an area of the contact on the screen; and
a changing unit that changes UI (User Interface) for inputting a predetermined instruction based on the contact detected by the touch detector.

2. The apparatus according to claim 1, wherein
the UI is for inputting the predetermined instruction based on a movement of a position of the contact detected by the touch detector when the area obtained by the area sensor is greater than a predetermined value or not smaller than a predetermined value, or
the UI is for inputting the predetermined instruction based on the position of the contact detected by the touch detector when the area detected by the area sensor is smaller than a predetermined value or not greater than a predetermined value.

3. The apparatus according to claim 2, wherein
the movement of the position of the contact detected by the touch detector is caused by at least one of move, flick, pinch-in and pinch-out.

4. The apparatus according to claim 2, wherein
the predetermined instruction is for setting a range of trimming the image displayed on the screen,
when the area obtained by the area sensor is greater than a predetermined value or not smaller than a predetermined value, a frame over the image is displayed on the screen based on the movement of the position of the contact detected by the touch detector, and a range corresponding to the frame is set as the range of the trimming, and
when the area obtained by the area sensor is smaller than the predetermined value or not greater than a predetermined value, a range with a vertex at the position of the contact detected by the touch detector is set as the range of the trimming.

5. An information processing method comprising:
displaying an image on a screen;
detecting contact on the screen;
obtaining an area of the contact on the screen; and
changing UI (User Interface) for inputting a predetermined instruction based on the detected contact.

6. A non-transitory computer-readable storage medium storing a program, the program causing a computer to execute:
displaying an image on a screen;
detecting contact on the screen;
obtaining an area of the contact on the screen; and
changing UI (User Interface) for inputting a predetermined instruction based on the detected contact.
